(19) United States
(12) Patent Application Publication
(10) Pub. No.: US 2008/0183111 A1
(43) Pub. Date: Jul. 31, 2008

(54) Device and method for generating shock waves

(76) Inventor: Axel Voss, Kreuzlingen (CH)

Correspondence Address: Raymond R. Ferrera;Adams and Reese, LLP, Suite 4400, 1221 McKinney, Houston, TX, 77010, US

(21) Appl. No.: 12/009,776

(22) Filed: Jan. 22, 2008

(30) Foreign Application Priority Data
Jan. 22, 2007 (DE) 10 2007 003 229.5

(51) Int. Cl. A61H 1/00

(52) U.S. Cl. 601/4

(57) ABSTRACT

The invention relates to a device for generating shock waves (1) comprising a first conductive tip (4) and a second conductive tip (5). The tips (4, 5) are arranged in a liquid bath (3). Furthermore a first voltage source (6) and a second voltage source (8) are provided for applying a voltage (U1, U2) between the first tip (4) and the second tip (5), wherein the first high voltage source (6) and the second high voltage source (8) are operated such that the voltages (U1, U2) are added up. Furthermore the invention relates to a method for operating a device for generating shock waves (1).

### STATEMENT OF RELATED CASES

Pursuant to 35 U.S.C. 119(a), the instant application claims priority to prior German application number 10 2007 003 229.5, filed Jan. 22, 2007.

The invention relates to a device and method for generating shock waves.

Nowadays, the generation of shock waves is used in various fields. The best-known field is the therapeutic and cosmetic application in the treatment for instance of calculous diseases (e.g. urolithiasis, cholelithiasis) and the treatment of scars in human and veterinary medicine.

New fields of application relate to dental treatment, the treatment of arthrosis, the ablation of calcerous deposits (e.g. tendinosis calcarea), the treatment of chronic tennis or golfer elbows (so called radial or ulnar epicondylopathy), of chronic discomfort of the shoulder tendons (so called enthesopathy of the rotator cuff), and of chronic irritation of the Achilles tendon (so called achillodynia).

Furthermore, the generation of shock waves is used in the therapy of osteoporosis, periodontosis, non-healing bone fractures (so called pseudoarthrosis), bone necrosis, and similar diseases. Newer trials investigate the application in stem cell therapy.

Furthermore, the generation of shock waves can be used to exert mechanical stress, e.g. in the form of shearing forces, on cells, wherein their apoptosis is initiated. This happens for example by means of an initiation of the ‘death receptor pathway’ and/or the cytochrome c-pathway and/or a caspase cascade.

The term apoptosis is understood to refer to the initiation of a genetically controlled program, which leads to the ‘cell suicide’ of individual cells in the tissue structure. As a result, the cells concerned and their organoids shrink and disintegrate into fragments, the so-called apoptotic bodies. These are phagocytized afterwards by macrophages and/or adjoining cells. Consequently, the apoptosis constitutes a non-necrotic cell death without inflammatory reactions.

Therefore, the application of shock waves is beneficial in all cases, where it relates to the treatment of diseases with an abased rate of apoptosis, e.g. treatment of tumors or viral diseases.

Additionally, the generation of shock waves can be applied beneficially in the treatment of necrotically changed areas or structures in muscle tissue, especially in tissue of the cardiac muscle, in the stimulation of cartilage assembly in arthritic joint diseases, in the initiation of the differentiation of embryonic or adult stem cells in vivo and in vitro in relation to the surrounding cell structure, in the treatment of tissue weakness, especially of cellulitis, and in the degradation of adipose cells, as well as the activation of growth factors, especially TGF-[beta].

Likewise, the generation of shock waves can be used for avoiding the formation and/or extension of edema, for degradation of edema, for the treatment of ischaemia, rheumatism, diseases of joints, jaw bone (periodontosis), cardiologic diseases and myocardial infarcts, pareses (paralyses), neuritis, paraplegia, arthrosis, arthritis, for the prevention of scar formation, for the treatment of scar formation respectively nerve scarring, for the treatment of achillobursitis and other bone necroses.

Another application relates to the treatment of spinal cord and nerve lesions, for example spinal cord lesions accompanied by the formation of edema.

Shock waves are also applicable for the treatment of scarred tendon and ligament tissue as well as badly healing open wounds.

Such badly healing open wounds and boils are called ulcus or also ulceration. They are a destruction of the surface by tissue disintegration at the dermis and/or mucosa. Depending on what tissue fractions are affected, surfacial lesions are called exfoliation (only epidermis affected) or excoriation (epidermis and corium affected).

Open wounds that can be treated with shock waves comprise especially chronic leg ulcers, hypertensive ischaemic ulcers, varicose ulcers or ulcus terebrans due to a thereby caused improved healing process.

Devices for disease treatment using shock waves usually comprise a base station and a treatment head which is conveyable to the place that needs treatment.

The treatment head comprises a device for generating shock waves. For this purpose, essentially three principles are available, namely the electro-hydraulic, the piezo-electric, and the electromagnetic principle.

According to prior art, most commonly an arrangement of metal tips in a liquid bath is used for generating electro-hydraulic shock waves. At the metal tips a high-voltage is applicable by means of a high-voltage circuit and a high-voltage switch (HV-switch) causing a voltage breakthrough between the tips which causes the liquid to vaporize and to generate shock waves by its sudden expansion. The high-voltage circuit often comprises a charging capacitor that has a certain capacity, wherein said capacity, when being discharged, leads to a controlled and reproducible deposing of energy within the shock circle formed by the metal tips in the liquid bath.

With the known arrangements it is frequently possible to produce different intensities of shock waves by modifying the distance between the metal tips and the high voltage at the high voltage circle.

The systems thereby show disadvantages which are outlined in the following.

On the one hand, the HV switches used in accordance with the prior art are affected by wear. This yields that the employed switches have quite frequently to be checked and exchanged. Particularly for equipment which is used in therapy, this leads to a considerably increased maintenance effort since for this intended use it is extremely important that the arrangements show no defects and malfunctions.

On the other hand, HV switches may cause irregularities in the production of shock waves by non-uniform closing speeds of the HV switches.

Further, an expensive control electronics is required as to be able to periodically open and close the HV switches.

Furthermore, the HV switches are additional components which increase the equipment price.

Starting from these disadvantages, it is an object of the present invention to provide a device and method for generating shock waves which eliminates the disadvantages of the prior art.

This object is solved by a device for generating shock waves in accordance with claim 1 and a method for generating shock waves in accordance with claim 10.

A device for generating shock waves according to the present invention comprises a first conductive tip and a second conductive tip wherein the tips are arranged in a liquid bath. The tips are aligned with each other and have a predefined distance from each other. For applying a voltage between the first and the second tip, a first voltage source and a second voltage source are provided which are operated such that the voltage between the tips corresponds to the sum of both voltage sources.

The device for generating shock waves according to the present invention makes it possible to do without HV switches.

The device for generating shock waves conveniently comprises a capacity which is connected in parallel with the tips. The capacity, preferably a capacitor, may be loaded by means of the voltage sources and may pass on a defined electric charge to the tips during the voltage breakthrough. This allows for a controlled, defined and reproducible generation of shock waves.

Conveniently, both the first voltage source and the second voltage source generate a voltage which is less than a breakdown voltage between the first and the second tip in the liquid bath. At least one of the voltage sources is conveniently regulable or controllable.

In virtue of the serial connection of the two voltage sources, the voltages generated by the two voltage sources are added up. The first voltage source may be configured such that the generated voltage is insignificantly lower than the breakdown voltage between the first and the second tip. Then the second voltage source must generate only a comparatively little voltage to exceed the necessary breakdown voltage.

The second voltage source conveniently comprises a transformer. The transformer may transform an applied voltage into a higher voltage so that a control or a regulation is possible for the low voltage side of the transformer by means of simple components.

Conveniently, a device is provided for settling the distance of the tips in the liquid bath. The breakdown voltage can be influenced by the tip distance and therewith the amount of energy passed on to the liquid bath during the breakthrough. In this way, a simple settling of a desired shock wave energy is possible. For that purpose, the voltage of the first voltage source conveniently is adapted to the changed distance of the tips. Particularly convenient is an automatic positioning of the tip distance.

The liquid bath conveniently has a conductivity of 20 μS/cm to 300 μS/cm wherein the distance of the tips conveniently is between 0.5 mm and 3 mm. Such liquid baths may uncomplicatedly be produced, for example hydrogenated water with a soupcon of palladium is suitable. Conveniently, the tips consist completely or partly of metal. Metal tips have proved themselves because of reliable function and ruggedness.

The voltage generated by the first voltage source conveniently is in the range of 5 to 20 kV. The voltage of the second voltage source conveniently is in the range of 1 kV to 10 kV. The breakdown voltage between the tips conveniently is 21 kV to 30 kV.

Putting the two voltage sources in a base station and the tips with the liquid bath in a hand unit is particularly favorable. The hand unit and the base station are connected to each other by means of a high voltage suitable cable, wherein the cable can conveniently be carried in a tube suitable for medical use together with further media transmission lines, if necessary. This makes the handling of the device for generating shock waves easier since such a hand unit is lightweight and compact.

Furthermore, the invention relates to a method for generating shock waves comprising the following method steps:
applying a first voltage between a first conductive tip and a second conductive tip, wherein the tips are arranged in a liquid bath;
applying a second voltage between the tips in such a manner that the first voltage and the second voltage add up between the tips to a voltage which is greater than the breakdown voltage between the tips.

By use of this method, an employment of a HV switch can be resigned and a favorable and reliable operation of a device for generating shock waves can be attained.

A tip distance between the first tip and the second tip conveniently is settled before applying the first or the second voltage. Settling the tip distance makes it possible to generate shock waves of variable strength.

The tips' distance conveniently is set to between 0.5 mm and 3 mm at a conductivity of the liquid in the liquid bath of 20 μS/cm to 300 μS/cm.

The first voltage is settled in the range of 5 kV to 20 kV and the second voltage in the range of 1 kV to 10 kV wherein the breakdown voltage is between 21 kV and 30 kV.

Water or a watery base conveniently is used as a liquid bath. For example, hydrogenated water with a soupcon of palladium is possible.

Providing the first voltage by means of a capacity connected in parallel with the tips is particularly advisable.

Another advantage consists in providing the second voltage at the tips by means of a high voltage source with a transformer.

In the following, the invention will be explained in detail with regard to the drawing. It is shown in:

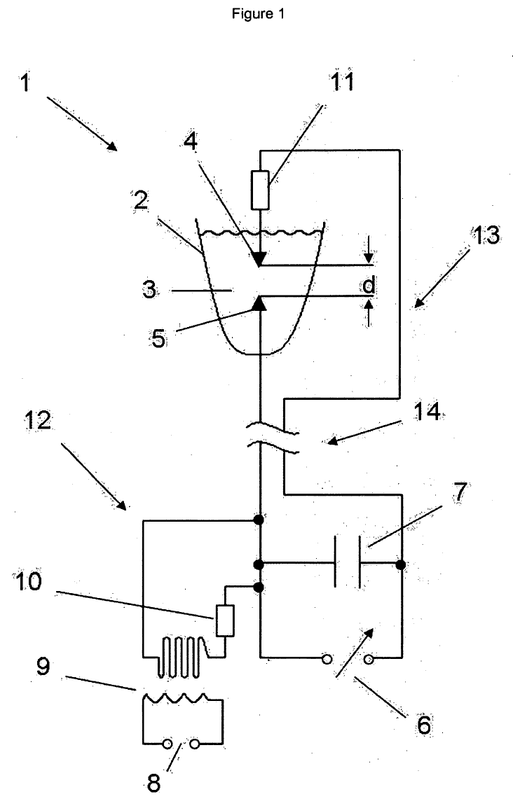

FIG. 1 a schematic illustration of a device for generating shock waves according to the present invention.

FIG. 1 shows a schematic illustration of a device for generating shock waves 1 according to the present invention.

The device for generating shock waves 1 comprises a reflector 2 which is filled with a liquid 3. The liquid 3 is hydrogenated water with a soupcon of palladium. A first tip 4 as well as a second tip 5 extend into the liquid 3 and are aligned with each other.

The two tips 4, 5 are attached to a first voltage source 6 wherein a capacitor 7 is switched parallel to the two tips 4, 5. The voltage source 6 generates a voltage U1.

Furthermore, a second voltage source 8 is provided that transforms a voltage on the low voltage side by means of a transformer 9 to a suitable high voltage U2. Furthermore, a resistance 10 is provided which prevents a short circuit.

The metal tips 4, 5 are spaced by a distance of between 0.5 mm and 3 mm. The breakdown voltage Ud between the tips is about 21 to 30 kV at a conductivity of the liquid between 20 μS/cm and 300 μS/cm. The tip distance d can be settled by means of altering facility 11. The altering facility 11 moves the tip 4 nearer to or further from the tip 5 so that d is extended or is reduced.

By means of the first voltage source 6 which provides the voltage U1 in the range of 5 kV to 20 kV and which is controllable, the capacitor 7 is loaded. The voltage U1 of the first voltage source 6 is chosen such that the breakdown voltage Ud between the tips 4, 5 is not reached. The breakdown voltage Ud between the tips 4, 5 is only exceeded by activation of the second voltage source 8 and by generating the voltage U2 between 1 kV and 10 kV. The voltage addition of the voltages U1 of the first voltage source 6 and the voltage U2 of the second voltage source 8 is carried out since the capacitor 7 and the tips 4, 5 are switched parallel with a transmission line section 12.

The second voltage source 8 thus provides merely a voltage rise by the voltage U2, a relevant current flow and thus a relevant power output of the second voltage source 8 do not take place. The second voltage source 8 therefore may be designed comparatively compact and at a reasonable price as a control circuit together with the transformer 9.

In the preferred embodiment, the first voltage source 6 is a controlled voltage source the voltage U1 of which is controlled subject to the tip distance d. The tip distance d influences the intensity of the generated shock wave. The longer the tip distance d is, the greater is the breakdown voltage Ud and the more energy is deposited in the liquid 3 and the more high-energy the produced shock wave gets.

The two voltage sources 6, 8 are placed in a base station 13 and the liquid filled reflector 2 with the tips 4, 5 in a hand unit 14. The base station 13 and the hand unit 14 are connected to each other by means of a tube 16 as to be able to lead the hand unit to the application site.

### LIST OF REFERENCE SIGNS

1 Device for generating shock waves
2 Reflector
3 Liquid
4 First tip
5 Second tip
6 First voltage source
7 Capacitor
8 Second voltage source
9 Transformer
10 Resistance
11 Altering facilities
12 Transmission line section
13 Base station
14 Hand unit
15 Tube
d Distance of the tips
U1 First voltage
U2 Second voltage
Ud Breakdown voltage

1. Device for generating shock waves (1), comprising a first conductive tip (4) and a second conductive tip (5), which are arranged in a liquid bath (3), characterized in that a first voltage source (6) and a second voltage source (8) are provided for applying a voltage (U1, U2), respectively, between the first tip (4) and the second tip (5), wherein the first voltage source (6) and the second voltage source (8) are operated such that the respective voltages (U1, U2) between the tips (4, 5) are added up.

2. Device for generating shock waves (1) according to claim 1, characterized in that the device for generating shock waves (1) comprises a capacity (7) which is connected in parallel with the tips (4, 5).

3. Device for generating shock waves (1) according to claim 1 or 2, characterized in that both the first voltage source (6) and the second voltage source (8) generate a voltage (U1, U2), respectively, which is lower than a breakdown voltage (Ud) between the first tip (4) and the second tip (5) in the liquid bath (3), wherein at least one of the voltage sources (6, 8) is regulable or controllable.

4. Device for generating shock waves (1) according to one of the claims 1 to 3, characterized in that the voltage (U1) of the first voltage source (6) is in the range of 5 kV to 20 kV and/or the voltage (U2) of the second voltage source (8) is in the range of 1 kV to 10 kV and/or the breakdown voltage (Ud) between the tips (4, 5) is 21 kV to 30 kV.

5. Device for generating shock waves according to one of the claims 1 to 4, characterized in that the second voltage source (8) comprises a transformer (9).

6. Device for generating shock waves (1) according to one of the claims 1 to 5, characterized in that a device (11) is provided for settling a distance (d) of the tips (4, 5) in the liquid bath (3).

7. Device for generating shock waves (1) according to one of the claims 1 to 6, characterized in that the liquid bath (3) has a conductivity of 20 μS/cm to 300 μS/cm and/or the distance (d) of the tips (4, 5) is between 0.5 mm and 3 mm.

8. Device for generating shock waves (1) according to one of the claims 1 to 7, characterized in that the tips (4, 5) completely or partly consist of metal.

9. Device for generating shock waves (1) according to one of the claims 1 to 8, characterized in that the first voltage source (6) and the second voltage source (8) are arranged in a base station (13) and the tips (4, 5) are arranged with the liquid bath (3) in an hand unit (14), wherein the hand unit (14) and the base station (13) are connected to each other by means of a high voltage suitable cable.

10. Method for generating shock waves, comprising the following steps:
applying a first voltage (U1) between a first conductive tip (4) and a second conductive tip (5) wherein the tips (4, 5) are arranged in a liquid bath (3);
applying a second voltage (U2) between the tips (4, 5) in such a way, that the first voltage (U1) and the second voltage (U2) add up to a voltage which is greater than a breakthrough voltage (Ud) between the tips (4, 5).

11. Method according to claim 10, characterized in that a tip distance (d) between the first tip (4) and the second tip (5) is settled before applying the first voltage (U1) or the second voltage (U2).

12. Method according to claim 10 or 11, characterized in that the settled distance of the tips (d) is between 0.5 mm and 3 mm at a conductivity of the liquid (3) in the liquid bath of 20 μS/cm to 300 μS/cm.

13. Method according to one of the claims 10 to 12, characterized in that the first applied voltage (U1) is in the range of 5 kV to 20 kV and/or the second applied voltage (U2) is in the range of 1 kV to 10 kV and/or the breakdown voltage (Ud) between the tips (4, 5) is 21 kV to 30 kV.

14. Method according to one of the claims 10 to 13, characterized by using water as a liquid bath (3).

15. Method according to one of the claims 10 to 14, characterized by providing the first voltage (U1) at the tips (4, 5) by means of a capacity (7) connected in parallel with the tips (4, 5).

16. Method according to one of the claims 10 to 15, characterized by providing the second voltage at the tips (4, 5) by means of a high voltage source with a transformer.
